(19) United States
(12) Patent Application Publication
(10) Pub. No.: US 2015/0130705 A1
(43) Pub. Date: May 14, 2015

(54) METHOD FOR DETERMINING LOCATION OF CONTENT AND AN ELECTRONIC DEVICE

(71) Applicant: Samsung Electronics Co., Ltd., Gyeonggi-do (KR)

(72) Inventor: Ho-Yeol IM, Seoul (KR)

(21) Appl. No.: 14/539,056

(22) Filed: Nov. 12, 2014

(30) Foreign Application Priority Data
Nov. 12, 2013 (KR) 10-2013-0136825

(51) Int. Cl. G06F 3/01

(52) U.S. Cl. CPC G06F 3/013
USPC 345/156

(57) ABSTRACT

A method is provided comprising: detecting, by an electronic device, whether at least a threshold amount of eye-gaze data is collected; selecting a first area in a display of the electronic device based on the eye-gaze data when the threshold amount of eye-gaze data is collected; and displaying a content item in the first area

### CLAIM OF PRIORITY

This application claims the benefit under 35 U.S.C. §119(a) of a Korean patent application filed in the Korean Intellectual Property Office on Nov. 12, 2013 and assigned Ser. No. 10-2013-0136825, the entire disclosure of which is hereby incorporated by reference.

### BACKGROUND

1. Field of the Disclosure

The present disclosure relates to method for determining a location of a content and an electronic device thereof.

2. Description of the Related Art

With the advancement of information communication techniques and semiconductor techniques, various electronic devices are under development into multimedia devices for providing various multimedia services. For example, the electronic device may provide a multimedia service such as a voice telephony service, a video telephony service, a messenger service, a broadcast service, a wireless Internet service, a camera service, and a music play service.

### SUMMARY

According to one aspect of the disclosure, a method is provided comprising: detecting, by an electronic device, whether at least a threshold amount of eye-gaze data is collected; selecting a first area in a display of the electronic device based on the eye-gaze data when the threshold amount of eye-gaze data is collected; and displaying a content item in the first area.

According to another aspect of the disclosure, an electronic device is provided comprising a display and a processor configured to: detect whether at least a threshold amount of eye-gaze data is collected; select a first area in the display based on the eye-gaze data when the threshold amount of eye-gaze data is collected; and display a content item in the first area.

### BRIEF DESCRIPTION OF THE DRAWINGS

The above and other aspects, features and advantages of certain aspects of the present disclosure will be more apparent from the following detailed description taken in conjunction with the accompanying drawings, in which:

FIG. 1 is a diagram of an example of an electronic device, according to aspects of the present disclosure;

FIG. 2 is a diagram of an example of an electronic device, according to aspects of the disclosure;

FIG. 3 is a diagram of an example software environment that can be executed on any one of the devices of FIG. 1 and FIG. 2 in accordance with aspects of the disclosure;

FIG. 4 is a diagram illustrating an example of a process for displaying content, according to aspects of the disclosure; FIG. 5A, FIG. 5B, FIG. 5C and FIG. 5D are diagrams illustrating an example of a process for displaying content, according to aspects of the disclosure;

FIG. 6A, FIG. 6B, FIG. 6C and FIG. 6D are diagrams illustrating example of a process for displaying content, according to aspects of the disclosure;

FIG. 7A, FIG. 7B, FIG. 7C and FIG. 7D are diagrams illustrating an example of a process for displaying content, in accordance with aspects of the disclosure;

FIG. 8 is a flowchart of an example of a process for displaying content, according to aspects of the disclosure;

FIG. 9 is a flowchart of an example of a process for displaying content, according to aspects of the disclosure; and

FIG. 10 is a flowchart of an example of a process for displaying content, according to aspects of the disclosure.

### DETAILED DESCRIPTION

Hereinafter, the present disclosure is described with reference to the accompanying drawings. An electronic device according to the present disclosure may be a device including a communication function. For example, the electronic device may be one or more combinations of various devices such as a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, an electronic bracelet, an electronic necklace, an electronic appcessory, a camera, a wearable device, an electronic clock, a wrist watch, a smart white appliance (e.g., a refrigerator, an air conditioner, a cleaner, an artificial intelligent robot, a TeleVision (TV), a Digital Video Disk (DVD) player, an audio, an oven, a microwave oven, a washing machine, an air purifier, an electronic picture frame, etc.), various medical devices (e.g., Magnetic Resonance Angiography (MRA), Magnetic Resonance Imaging (MRI), Computed Tomography (CR), imaging equipment, ultrasonic instrument, etc.), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, an electronic equipment for ship (e.g., a vessel navigation device, a gyro compass, etc.), avionics, a security device, an electronic costume, an electronic key, a camcorder, game consoles, a Head-Mounted Display (HMD), a flat panel display device, an electronic album, a furniture or a part of building/constructions including a communication function, an electronic board, an electronic signature receiving device, a projector, and the like. It is apparent to those ordinarily skilled in the art that the electronic device according to the present disclosure is not limited to the aforementioned devices.

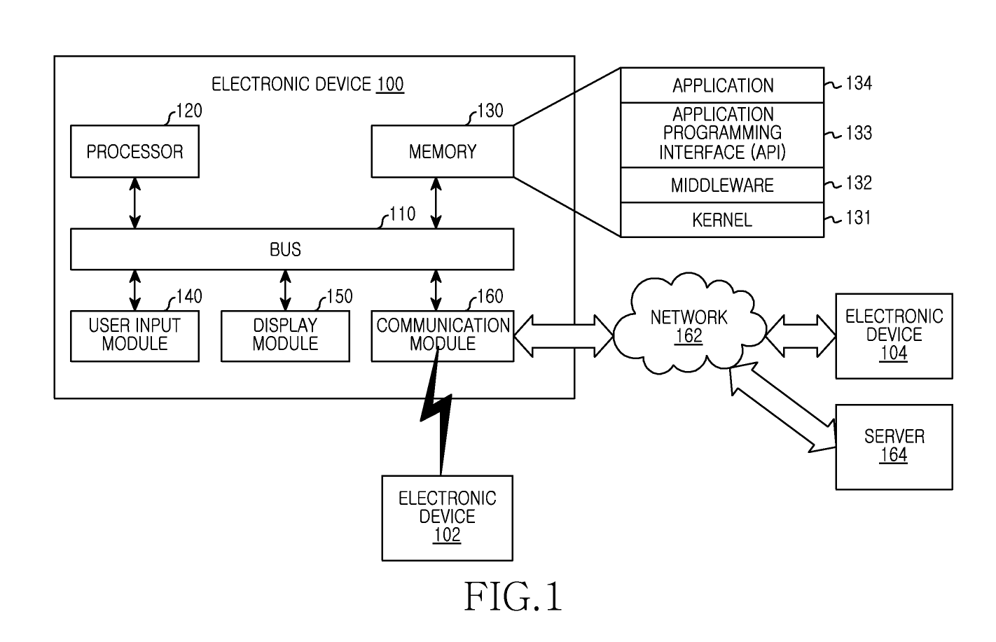

FIG. 1 is a diagram of an example of an electronic device, according to aspects of the present disclosure. Referring to FIG. 1, an electronic device 100 is shown which may include a bus 110, a processor 120, a memory 130, a user input module 140, a display module 150, or a communication module 160.

The bus 110 may be a circuit for connecting the aforementioned components and for delivering a communication (e.g., a control message) between the aforementioned components.

The processor 120 may include processing circuitry, such as a processor (e.g., an ARM-based processor, an x86-based processor, etc.), an Application Specific Integrated Circuit (ASIC), a Field-Programmable Gate Array (FPGA), and/or any other suitable type of processing circuitry. The processor 120 may receive an instruction from other components (e.g., the memory 130, the user input module 140, the display module 150, the communication module 160, etc.), for example, via the bus 110, and thus may interpret the received instruction and execute arithmetic or data processing according to the interpreted instruction.

The memory 130 may include any suitable type of volatile and non-volatile memory, such as Random Access Memory (RAM), a Solid State Drive (SSD), a Hard Drive (HD), Read-Only Memory (ROM), etc. The memory 130 may store an instruction or data received from the processor 120 or other components (e.g., the user input module 140, the display module 150, the communication module 160, etc.) or generated by the processor 120 or other components. The memory 130 may include programming modules such as a kernel 131, a middleware 132, an Application Programming Interface (API) 133, an application 134, and the like. Each of the aforementioned programming modules may consist of software, firmware, or hardware entities or may consist of at least two or more combinations thereof.

The kernel 131 may control or manage the remaining other programming modules, for example, system resources (e.g., the bus 110, the processor 120, the memory 130, etc.) used to execute an operation or function implemented in the middleware 132, the API 133, or the application 134. In addition, the kernel 131 may provide a controllable or manageable interface by accessing individual components of the electronic device 100 in the middleware 132, the API 133, or the application 134.

The middleware 132 may perform a mediation role so that the API 133 or the application 134 communicates with the kernel 131 to exchange data. In addition, regarding task requests received from the (plurality of) applications 134, the middleware 132 may perform load balancing for the task request by using a method of assigning a priority and the like capable of using a system resource (e.g., the bus 110, the processor 120, the memory 130, etc.) of the electronic device 100 to at least one application among the (plurality of) applications 134.

The API 133 may include at least one interface or function for file control, window control, video processing, or character control, and the like, as an interface capable of controlling a function provided by the application 134 in the kernel 131 or the middleware 132.

The user input module 140 may receive an instruction or data from a user and deliver it to the processor 120 or the memory 130 via the bus 110. The display module 150 may display video, image, data, and the like, to the user.

The communication module 160 may include any suitable type of wired or wireless transmitter and/or wired or wireless receiver. The communication module 160 may connect a communication between another electronic device 102 and the electronic device 100. The communication module 160 may support a specific near-field communication protocol (e.g., Wireless Fidelity (WiFi), Bluetooth (BT), Near Field Communication (NFC), or specific network communication 162 (e.g., Internet, Local Area Network (LAN), Wide Area Network (WAN), telecommunication network, cellular network, satellite network, Plain Old Telephone Service (POTS), etc.). Each of the electronic devices 102 and 104 may be a device which is the same (e.g., the same type) as the electronic device 100 or may be a different (e.g., a different type) device.

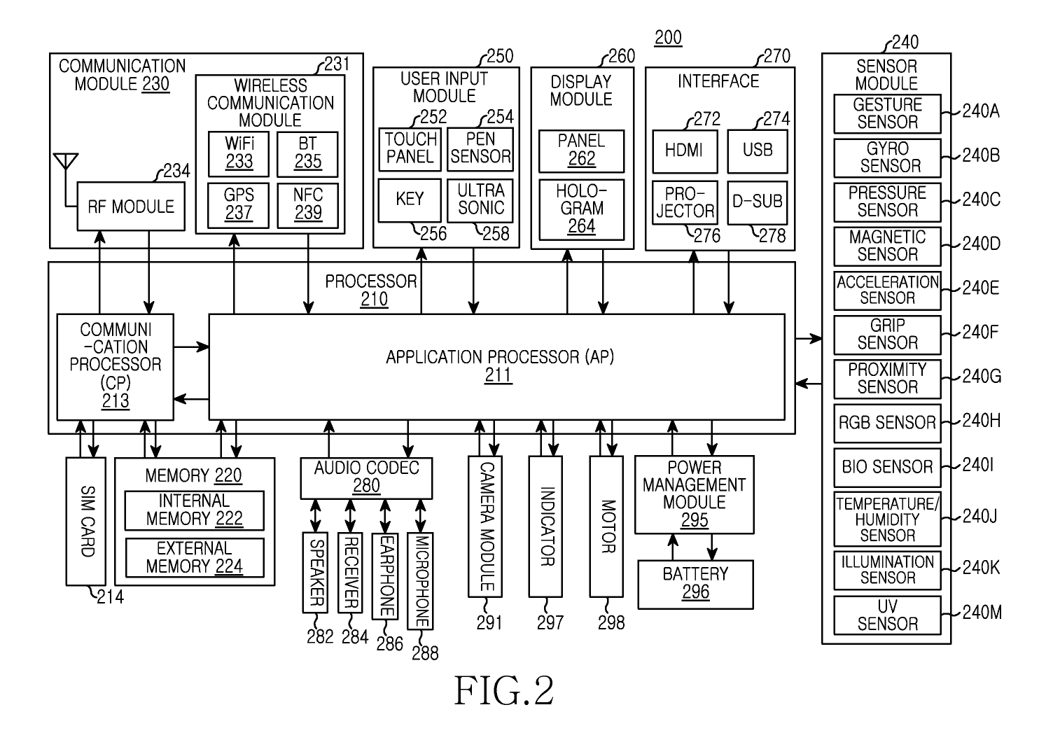

FIG. 2 is a diagram of an example of an electronic device, according to aspects of the disclosure. A hardware 200 may be the electronic device 100 of FIG. 1. Referring to FIG. 2, the hardware 200 may include one or more processors 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, or a motor 298.

The processors 210 (e.g., the aforementioned processor 120) may include one or more Application Processors (APs) 211 or one or more Communication Processors (CPs) 213. The processor 210 may be the processor 120 of FIG. 1. Although it is described in FIG. 2 that the AP 211 and the CP 213 are included in the processor 210, the AP 211 and the CP 213 may be respectively included in different Integrated Circuit (IC) packages. In one aspect, the AP 211 and the CP 213 may be included in one IC package. In the present disclosure, the processor 210 may decide whether eye-gaze data is accumulated more than a pre-set data amount, and may determine a target area for displaying a content when it is decided that the eye-gaze data is accumulated in excess of a threshold amount. In addition, the processor 210 may analyze the eye-gaze data and may identify an area in which a user's eye-gaze is held more than a pre-set time or an area in which the user's eye-gaze is held less than the pre-set time as the target area. In addition, the processor 210 may decide whether an initially displayed screen is changed to a different screen. In addition, the processor 210 may decide whether the initially displayed screen is changed to the different screen, and may confirm that a specific application is executed.

The AP 211 may control a plurality of hardware or software components connected to the AP 211 by driving an operating system or an application program, and may perform a variety of data processing and computation including multimedia data. The AP 211 may be implemented with a System on Chip (SoC). According to one aspect, the processor 210 may further include a Graphic Processing Unit (GPU, not shown).

The CP 213 may perform a function of managing a data link and converting a communication protocol in a communication between other electronic devices connected with an electronic device (e.g., the electronic device 100) including the hardware 200 through a network. The CP 213 may be implemented with a SoC. According to one aspect, the CP 213 may perform at least a part of a multimedia control function. The CP 213 may identify and authenticate a terminal in a communication network by using a Subscriber Identification Module (SIM) (e.g., the SIM card 214). In addition, the CP 213 may provide the user with services such as voice telephony, video telephony, text messages, packet data, and the like.

In addition, the CP 213 may control data transmission/reception of the communication module 230. Although in the example of FIG. 2 components such as the CP 213, the power management module 295, the memory 220, and the like, are depicted separate components in some implementations any of those components may be integrated together and/or integrated into the AP 211.

According to aspects of the disclosure, the AP 211 or the CP 213 may load an instruction or data, received from a non-volatile memory connected thereto or at least one of other components, to a volatile memory and then may process the instruction or data. In addition, the AP 211 or the CP 213 may store data, received from the at least one of other components or generated by the at least one of other components, into the non-volatile memory.

The SIM card 214 may be a card in which a SIM is implemented, and may be inserted to a slot formed at a specific location of the electronic device. The SIM card 214 may include unique identification information (e.g., an Integrated Circuit Card Identifier (ICCID)) or subscriber information (e.g., an International Mobile Subscriber Identity (IMSI)).

The memory 220 may include an internal memory 222 or an external memory 224. The memory 220 may be the memory 130 of FIG. 1. The internal memory 222 may include at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.). According to one aspect, the internal memory 222 may have a form of a Solid State Drive (SSD). The external memory 224 may further include Compact Flash (CF), Secure Digital (SD), Micro Secure Digital (Micro-SD), Mini Secure Digital (Mini-SD), extreme Digital (xD), memory stick, and the like.

The communication module 230 may include a wireless communication module 231 or a Radio Frequency (RF) module 234. The communication module 230 may be the communication module 160 of FIG. 1. The wireless communication module 231 may include a WiFi 233, a BlueTooth (BT) 235, a Global Positioning System (GPS) 237, or a Near Field Communication (NFC) 239. For example, the wireless communication module 231 may provide a wireless communication function by using a radio frequency. Additionally or alternatively, the wireless communication module 231 may include a network interface (e.g., a LAN card), modem, and the like for connecting the hardware 200 to a network (e.g., Internet, LAN, WAN, telecommunication network, cellular network, satellite network, POTS, etc.). The communication module 230 of the present disclosure may be used to transmit information to a server for providing content (e.g., an ad server).

The RF module 234 may serve to transmit/receive data, for example, an RF signal or a paged electronic signal. Although not shown, the RF module 234 may include a transceiver, a Power Amp Module (PAM), a frequency filter, a Low Noise Amplifier (LNA), and the like. In addition, the RF module 234 may further include a component, e.g., a conductor, a conducting wire, and the like, for transmitting/receiving a radio wave on a free space in a wireless communication.

The sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a Red, Green, Blue (RGB) sensor 240H, a bio sensor 240I, a temperature/humidity sensor 240J, an illumination sensor 240K, and an Ultra Violet (UV) sensor 240M. The sensor module 240 may measure a physical quantity or detect an operation state of the electronic device, and thus may convert the measured or detected information into an electric signal. Additionally/alternatively, the sensor module 240 may include an E-node sensor (not shown), an ElectroMyoGraphy (EMG) sensor (not shown), an ElectroEncephaloGram (EEG) sensor (not shown), an ElectroCardioGram (ECG) sensor (not shown), a fingerprint sensor, and the like. The sensor module 240 may further include a control circuit for controlling at least one or more sensors included therein.

The user input module 250 may include a touch panel 252, a (digital) pen sensor 254, a key 256, or an ultrasonic input unit 258. The user input module 250 may be the user input module 140 of FIG. 1. The touch panel 252 may recognize a touch input by using at least one of an electrostatic type, a pressure-sensitive type, an infrared type, and an ultrasonic type. In addition, the touch panel 252 may further include a controller (not shown). In case of the electrostatic type, not only direct touch but also proximity recognition is also possible. The touch panel 252 may further include a tactile layer. In this case, the touch panel 252 may provide the user with tactile feedback.

The (digital) pen sensor 254 may be implemented by using the same or similar method of receiving a touch input of the user or by using an additional sheet for recognition. The key 256 may be a keypad or a touch key. The ultrasonic input unit 258 is a device by which a terminal detects a sound wave through a microphone (e.g., a microphone 288) by using a pen which generates an ultrasonic signal, and is a device capable of radio recognition. According to one aspect, the hardware 200 may use the communication module 230 to receive a user input from an external device (e.g., a network, a computer, or a server) connected thereto.

The display module 260 may include a panel 262 or a hologram 264. The display module 260 may be the display module 150 of FIG. 1. The panel 262 may be a Liquid-Crystal Display (LCD), an Active-Matrix Organic Light-Emitting Diode (AM-OLED), and the like. The panel 262 may be implemented in a flexible, transparent, or wearable manner. The panel 262 may be constructed as one module with the touch panel 252. The hologram 264 may use an interference of light and show a stereoscopic image in the air. According to one aspect, the display module 260 may further include a control circuit for controlling the panel 262 or the hologram 264.

The interface 270 may include a High-Definition Multimedia Interface (HDMI) 272, a Universal Serial Bus (USB) 274, a projector 276, or a D-subminiature (D-sub) 278. Additionally or alternatively, the interface 270 may include Secure Digital (SD)/Multi-Media Card (MMC) (not shown) or Infrared Data Association (IrDA) (not shown).

The audio codec 280 may convert audio information which is input or output through a speaker 282, a receiver 284, an earphone 286, the microphone 288, and the like.

The camera module 291 is a device for image and video capturing, and according to one aspect, may include one or more image sensors (e.g., a front lens or a rear lens), an Image Signal Processor (ISP) (not shown), or a flash Light Emitting Diode (LED) (not shown).

The power management module 295 may manage power of the hardware 200. Although not shown, the power management module 295 may include a Power Management Integrated Circuit (PMIC), a charger Integrated Circuit (IC), or a battery fuel gauge.

The PMIC may be equipped inside an IC or SoC semiconductor. Charging may be classified into wired charging and wireless charging. The charger IC may charge a battery, and may avoid over-voltage or over-current flowing from a charger. According to one aspect, the charger IC may further include a charger IC for at least one of the wired charging and the wireless charging. The wireless charging may be classified into a magnetic resonance type, a magnetic induction type, and an electromagnetic type. An additional circuit for the wireless charging may be added, such as a coil loop, a resonant circuit, a rectifier, and the like.

The battery gauge may measure a residual power of the battery 296 and a voltage, current, and temperature during charging. The battery 296 may generate electricity to supply power source, and may be a rechargeable battery.

The indicator 297 may indicate a specific state, e.g., a booting state, a message state, a charging state, and the like, of the hardware 200 or a part thereof (e.g., the AP 211). The motor 298 may convert an electric signal into a mechanical vibration. An MCU(Main Control Unit) (not shown) may control the sensor module 240.

Although not shown, the hardware 200 may include a processing unit (e.g., a GPU) for supporting mobile TV. The processing unit for supporting mobile TV may process media data according to a protocol of, for example, Digital Multimedia Broadcasting (DMB), Digital Video Broadcasting (DVB), media flow, and the like.

Names of the aforementioned components of the hardware according to the present disclosure may vary depending on a type of electronic device. The hardware of the present disclosure may include at least one of the aforementioned components. Some of the components may be omitted, or additional other components may be further included. In addition, some of the components of the hardware of the present disclosure may be combined and constructed to one entity, so as to equally perform functions of corresponding components before combination.

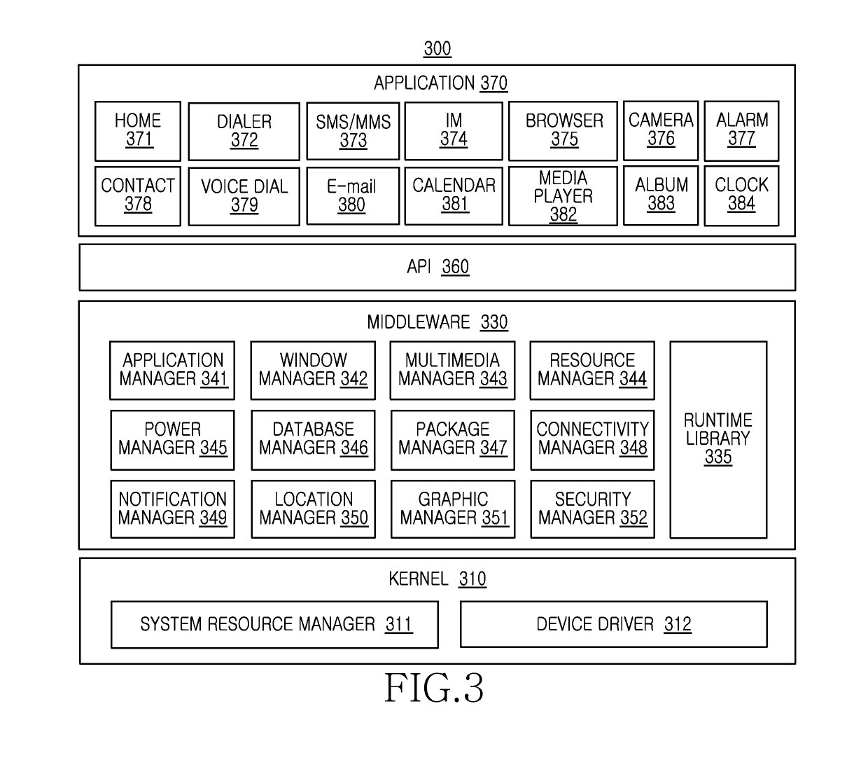

FIG. 3 is a diagram of an example software environment that can be executed on any one of the devices of FIG. 1 and FIG. 2 in accordance with aspects of the disclosure. A programming module 300 may be included (e.g., stored) in the electronic device 100 (e.g., the memory 130) of FIG. 1. At least some parts of the programming module 300 may consist of software, firmware, hardware, or a combination of at least two or more of them. The programming module 300 may include an Operating System (OS) implemented in a hardware (e.g., the hardware 200) and controlling a resource related to an electronic device (e.g., the electronic device 100) or various applications (e.g., an application 370) driven on the OS. For example, the OS may be Android, iOS, Windows, Symbian, Tizen, Bada, and the like. Referring to FIG. 3, the programming module 300 may include a kernel 310, a middleware 330, an Application Programming Interface (API) 360, or the application 370.

The kernel 310 (e.g., the kernel 131) may include a system resource manager 311 or a device driver 312. The system resource manager 311 may include a process managing unit (not shown), a memory managing unit (not shown), a file system managing unit (not shown), and the like. The system resource manager 311 may perform control, allocation, retrieval, and the like of the system resource. The device driver 312 may include a display driver (not shown), a camera driver (not shown), a Bluetooth driver (not shown), a shared memory driver (not shown), a USB driver (not shown), a keypad driver (not shown), a WiFi driver (not shown), or an audio driver (not shown). In addition, the device driver 312 may include an Inter-Process Communication (IPC) driver (not shown).

The middleware 330 may include a plurality of modules pre-implemented to provide a function commonly required by the application 370. In addition, the middleware 330 may provide a function through the API 360 so that the application 370 can effectively use a limited system resource in the electronic device. For example, as shown in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module used by a compiler to add a new function through a programming language while the application 370 is executed. According to one aspect, the runtime library 335 may perform an operation of an input/output, a memory management, an arithmetic function, and the like.

The application manager 341 may manage a life cycle of at least one application among the applications 370. The window manager 342 may manage a Graphic User Interface (GUI) resource used in a screen. The multimedia manager 343 may recognize a format required to reproduce various media files, and may use a code suitable for the format to perform encoding or decoding of the media file. The resource manager 344 may manage a resource (e.g., a source code, a memory, a storage space, etc.) of at least any one of the applications 370.

The power manager 345 may manage a battery or power by operating together with a Basic Input/Output System (BIOS), and the like, and may provide power information, and the like, required for the operation. The database manager 346 may manage to generate, search, or change a database to be used in at least one application among the applications 370. The package manager 347 may manage an installation or update of an application distributed in a form of a package file.

The connectivity manager 348 may manage a wireless connection such as WiFi, Bluetooth, and the like. The notification manager 349 may display or notify an event such as an incoming message, an appointment, a proximity notification, and the like, in a manner of not disturbing the user. The location manager 350 may manage location information of the electronic device. The graphic manager 351 may manage a graphic effect to be provided to the user or a user interface related thereto. The security manager 352 may provide a general security function required for system security, user authentication, and the like. According to one aspect, if the electronic device (e.g., the electronic device 100) has a telephone function, the middleware 330 may further include a telephony manager (not shown) for managing a voice or video telephony function of the electronic device.

The middleware 330 may generate and use a new middleware module by combining various functions of the aforementioned internal constitutional modules. The middleware 330 may provide a module specified for each type of operating system to provide a differentiated function. In addition, the middleware 330 may dynamically delete some of the existing components or may add new components. Therefore, some of the components described in this example may be omitted, or other components may be further included or may be replaced with components having other names for performing a similar function.

The API 360 (e.g., the API 133) is a set of API programming functions, and may be provided with other configurations according to an operating system. For example, in case of Android or IOS, one API set may be provided for each platform, and in case of Tizen, two or more API sets may be provided.

The application 370 (e.g., the application 134) may include a preloaded application or a third party application.

At least some parts of the programming module 300 may be implemented as a set of one or more processor-executable instructions stored in a non-transitory computer-readable storage medium. If the set of instructions is executed by one or more processors (e.g., the processor 210), the one or more processors may perform a function corresponding to the instruction. The computer-readable storage media may be the memory 260. At least some parts of the programming module 300 may be implemented (e.g., executed) by the processor 210. At least some parts of the programming module 300 may include modules, programs, routines, sets of instructions, processes, and the like, for performing one or more functions.

Names of components of the programming module (e.g., the programming module 300) according to the present disclosure may vary depending on a type of operating system. In addition, the programming module according to the present disclosure may further include at least one or more components among the aforementioned components, or some of them may be omitted, or additional other components may be further included.

According to another aspect of the present disclosure, an electronic device comprising: a processor for deciding whether eye-gaze data is accumulated more than a pre-set data amount, and if it is decided that the eye-gaze data is accumulated more than the pre-set data amount, for determining a target area for displaying a content based on the eye-gaze data; and a display module for displaying the content in the determined target area.

According to another aspect of the present disclosure, wherein the eye-gaze data is data acquired by detecting at least one of an area in which a user's eye-gaze is held and a time thereof by using a provided camera module.

According to another aspect of the present disclosure, wherein the processor analyzes the eye-gaze data accumulated more than the pre-set data amount, and determines any one of an area in which a user's eye-gaze is held more than a pre-set time and an area in which the user's eye-gaze is held less than the pre-set time as the target area.

According to another aspect of the present disclosure, wherein the processor decides whether an initially displayed screen is changed to a different screen, and further comprising a communication module for, if it is decided that the screen is changed to the different screen, transmitting data acquired by analyzing the eye-gaze data to a server, and receiving the content from the server.

According to another aspect of the present disclosure, the content may be initially displayed in a default area corresponding to an application that is currently being executed and subsequently relocated to the target area. According to another aspect of the present disclosure, the target area may be any one of an area in which a user's eye-gaze is held more than a pre-set time and an area in which the user's eye-gaze is held less than the pre-set time as the second area.

According to another aspect of the present disclosure, wherein the processor decides whether an initially displayed screen is changed to a different screen, and if it is decided that the screen is changed to the different screen, transmits data acquired by analyzing the eye-gaze data to a server, and receives the content from the server.

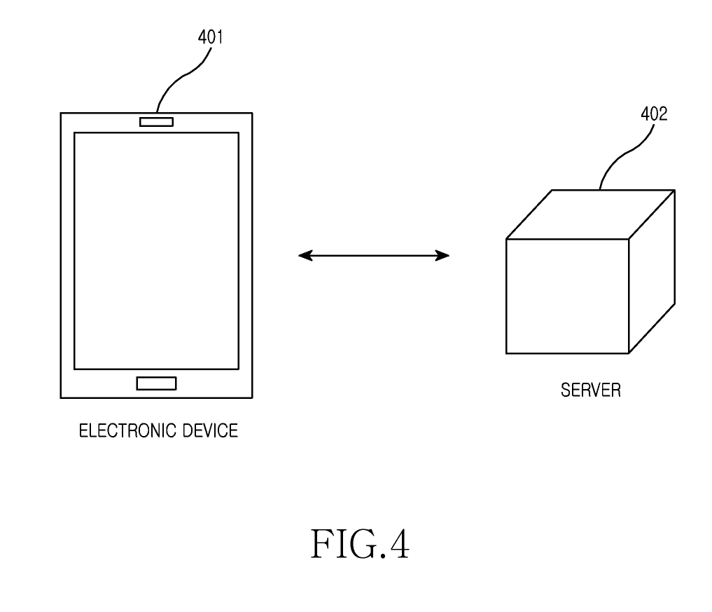

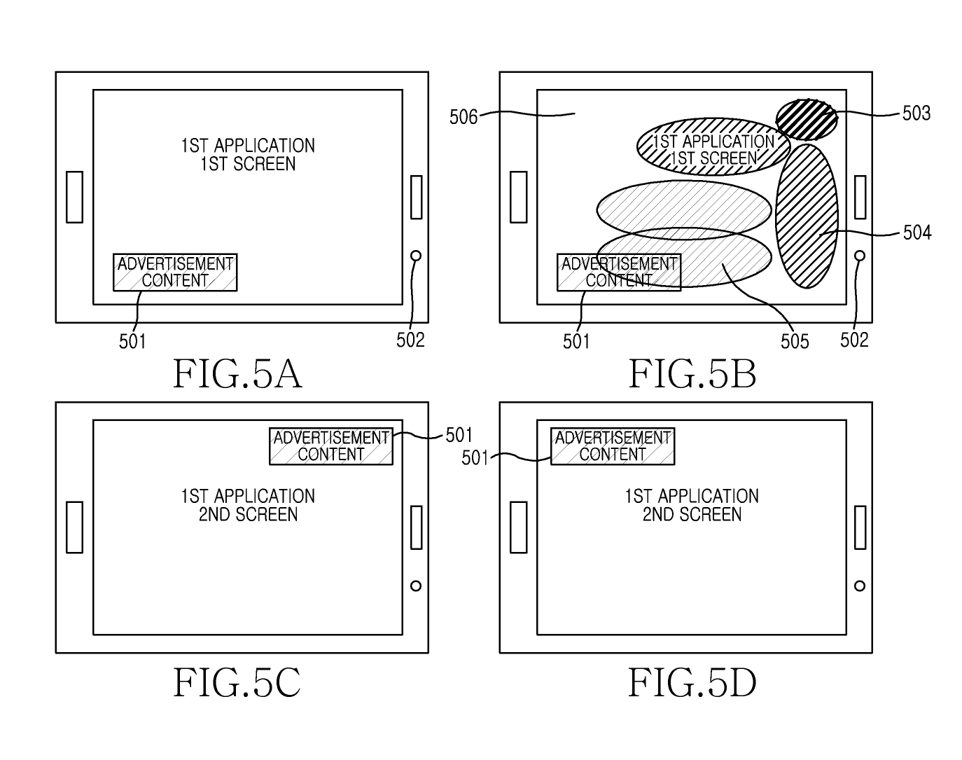

FIG. 4 is a diagram illustrating an example of a process for displaying content, according to aspects of the disclosure. First, as shown in FIG. 4, an electronic device 401 may be operatively coupled (e.g., via a wired or wireless network connection) with a server 402 and may receive a content, transmitted from the server 402, to be displayed in a display of the electronic device 401 concurrently with the user interface of an application that is currently executed by the electronic device 401.

In operation, the electronic device 401 may accumulate eye-gaze data. The eye-gaze data may include one or more data items. Each data item may indicate a location and/or direction of a user's eye-gaze relative to a display screen of the electronic device 401. The eye-gaze data may be accumulated by using a camera module included in the electronic device 401. If the amount of accumulated eye-gaze data exceeds a threshold amount, the electronic device 401 may select a target area for displaying the content based on the eye-gaze data. For example, the target area may be selected based on at least one of: (i) a total amount of time for which an eye-gaze is directed at the target area during a period in which the eye-gaze data is collected (ii) a duration of the longest gaze that is maintained on the area, or (iii) a frequency with which an eye-gaze is directed at the target area.

Thereafter, the electronic device 401 may detect whether an initially-displayed first application screen is replaced by a second application screen. In response to detecting that the first screen is replaced by the second screen, the electronic device 401 may display the content in the selected target area.

For example, when the eye-gaze data indicates that the area in which the user's eye-gaze is held more than the pre-set time may be a right upper area of the electronic device 401 and the initial default area may be a left upper area. The electronic device 401 may display the content in the right upper area which is an area in which the user's eye-gaze is held more than the pre-set time. For instance, if the electronic device 401 detects that the initially displayed screen is changed to the different screen while displaying the content in the left upper area which is the initial default area, the electronic device 401 may move the content to the right upper area of the new screen.

FIGS. 5A, 5B, 5C and 5D are diagrams illustrating an example of a process for displaying content, according to aspects of the disclosure. First, an instruction for executing a specific application may be input to an electronic device. For example, an icon of a first application may be selected in the electronic device from icons of a plurality of applications displayed in a display module of the electronic device.

Thereafter, the electronic device may display the content in a pre-set default area together while executing an application for which an execution instruction is input. For example, as shown in FIG. 5A, the content may be displayed in a left lower area of the display of the electronic device, and the content may be advertising content. More specifically, in the example of FIG. 5A, e, the electronic device may execute the first application, and may display advertising content 501 in the left lower area while displaying the first screen of the first application in the display module of the electronic device.

Thereafter, the electronic device may accumulate eye-gaze data by using a camera module 502 included in the electronic device. More specifically, the electronic device may detect an area in which a user's eye-gaze is held among areas of the display module of the electronic device, a time thereof, and the like, by using the camera module 502 included in the electronic device. Herein, the eye-gaze data may be data acquired by detecting at least one of the area in which the user's eye-gaze is held and the time the time for which the user's eye gaze is held at that area.

Thereafter, the electronic device may decide whether the amount of accumulated eye-gaze exceeds a threshold. For example, if the pre-set data amount in the electronic device is 1 MegaByte (MB), the electronic device may decide whether more than 1 MB of eye-gaze data is accumulated.

Thereafter, if it is decided in the electronic device that the amount of eye-gaze data exceeds the threshold, the electronic device may determine a target area for displaying the content. More specifically, the electronic device may analyze the eye-gaze data to identify an area in which a user's eye-gaze is held more than a pre-set time or an area in which the user's eye-gaze is held less than the pre-set time as the target area.

For example, the selected target area may be one of: an area where a user's gaze is directed most frequently, an area where the user's gaze is directed least frequently, an area where the user's gaze is directed for the longest time from among other areas in the display of the electronic device, an area where the user's gaze is directed for the least among of time from among other areas in the display of the electronic device, and/or any other suitable type of area.

For example, as shown in FIG. 5B, as a result of analyzing the eye-gaze data, an area may be identified (i.e., a 1^{st} eye-gaze area 503) in which the user's eye-gaze is held most frequently, and/or an area (i.e., a 2^{nd} eye-gaze area 504) in which the user's eye-gaze is held most frequently next to the 1^{st} eye-gaze area 503, and/or an area (i.e., a 3^{rd} eye gaze area 505) in which the user's eye-gaze is held most frequently next to the 2^{nd} gaze area, and/or an area (i.e., a 4^{th} eye-gaze area 506) in which the user's eye-gaze is held least frequently, and such a case will be described below. According to aspects of the disclosure, any one of these areas may be selected as a target area.

In the aforementioned example, if the area in which a user's eye-gaze is held most frequently is selected as the target area, the electronic device may display a content in the first eye-gaze area 503 so that the displayed content can be more easily noticed by the user. In some aspects, when the content is an advertisement, it may be desirable to display the advertisement in this manner so as to increase the efficiency at which the advertisement is delivered to the user.

Alternatively, if the electronic device detects that the area in which the user's eye-gaze is held least frequently (or for the shortest amount of time) is the eye-gaze area 505, the electronic device may display the content in the eye-gaze area 505. In this manner, the content may be presented without distracting the user excessively. In instances in which the content is an advertisement, if the content is displayed in the eye-gaze area 505 in which the user's eye-gaze is held least frequently, an advertising impact can be persistently achieved without the presentation of the content becoming irritating to the user.

Thereafter, the electronic device may decide whether the initially displayed screen is changed to a different screen. More specifically, the electronic device may detect whether a first screen for the first application is changed to a second screen. For example, the electronic device may execute a chatting application in the first screen with respect to a first user, i.e., a “User A”. Then, the first screen which is under execution to chat to a “User B” is finished, and it may be decided whether the screen is changed to the second screen.

If it is decided in the electronic device that the screen is changed to the different screen, the electronic device may transmit data acquired by analyzing the eye-gaze data to a server. Thereafter, the electronic device may receive the content from the server, and may display the content in the determined target area.

For example, as shown in FIG SC, it the area where the user's gaze is most frequently directed may be the right upper area of the display of the electronic device, the area where a content is initially displayed may be a left lower area, and the content may be an advertising content. In the aforementioned example, if it is detected that the electronic device transitions from displaying a first screen to displaying a second screen, the electronic device may move the advertising content in the right upper area which is the determined target area. Thus, according to one aspect of the disclosure, the switch between two screens may trigger the moving of the content from one location to the other.

As another example, as shown in FIG. SD, the portion of a display screen of the electronic device where the a user's gaze is most frequently directed may be a left upper area of the electronic device, the initial default area where content is initially displayed may be a left lower area, and the content may be advertising content. In the aforementioned example, if it is confirmed that the electronic device is changed from the first screen of the first application to the second screen, the electronic device may display the advertisement content in the left upper area.

In this example, the content is displayed in the target area only when it is confirmed that the electronic device switches from displaying a first screen to displaying a second screen in place of the first screen, in order not to distract the user.

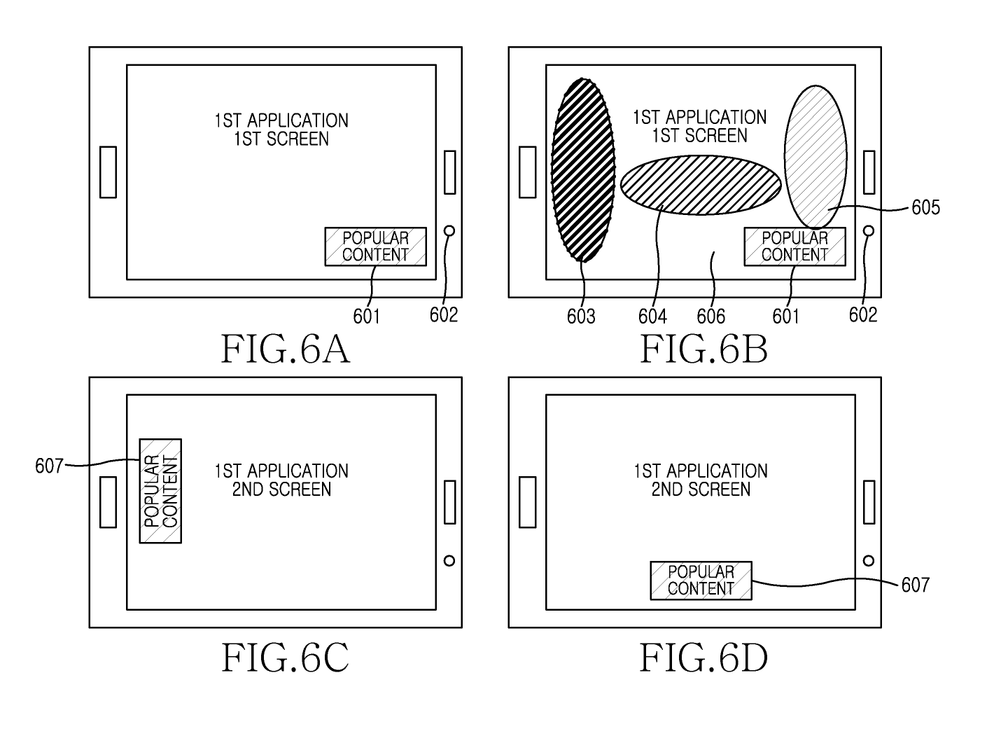

FIGS. 6A, 6B, 6C and 6D are diagrams illustrating example of a process for displaying content, according to aspects of the disclosure. First, an instruction for executing a specific application may be input to an electronic device. For example, an icon of a first application may be selected in the electronic device from icons of a plurality of applications displayed in a display module of the electronic device.

Thereafter, the electronic device may superimpose the content in a default area of the display of the electronic device over a first screen of the first application. For example, as shown in FIG. 6A, the default area for displaying the content in the electronic device may be a right lower area, and the content may be a popular content. In addition, it will be described a case where an instruction for executing the first application is input to the electronic device among a plurality of applications installed in the electronic device, and the first screen which is an initial screen of the first application is displayed.

In the above example, the electronic device may execute the first application, and may display a popular content 601 in the right lower area while displaying the first screen of the first application in the display of the electronic device.

Thereafter, the electronic device may accumulate eye-gaze data by using a camera module 602 included in the electronic device. More specifically, the electronic device may detect an area in which a user's eye-gaze is held among areas of the display module of the electronic device, a time thereof, and the like, by using the camera module 602 included in the electronic device.

Thereafter, if it is decided in the electronic device that the amount of accumulated eye-gaze data exceeds a threshold, the electronic device may determine a target area for displaying the content. More specifically, the electronic device may analyze the eye-gaze data and may determine any one of an area in which a user's eye-gaze is held more than the pre-set time and an area in which the user's eye-gaze is held less than the pre-set time as the target area.

For example, as shown in FIG. 6B, as a result of analyzing the eye-gaze data accumulated more than the pre-set data amount by the electronic device, an area may be identified (i.e., a an eye-gaze area 603) in which the user's eye-gaze is held most frequently, and/or an area (i.e an eye-gaze area 604) in which the user's eye-gaze is held most frequently after the eye-gaze area 603, and/or an area (i.e., a an eye-gaze area 605) in which the user's eye-gaze is held most frequently after the second eye-gaze area, and/or an area (i.e., a an eye-gaze area 606) in which the user's eye-gaze is held least frequently, and such a case will be described below. According to aspects of the disclosure, any one of these areas may be selected as a target area.

In the aforementioned example, the electronic device may select a target area where content is to be displayed by analyzing eye-gaze data. For example, the target area may be an area on the display of the electronic device at which a user's gaze is most frequently directed from among two or more areas in the display of the electronic device and/or an area where the user's gaze is directed for the longest period of time from among two or more areas in the display of the electronic device.

Thereafter, the electronic device may detect whether the initially displayed screen is changed to a different screen. More specifically, the electronic device may detect whether the first screen for the first application is changed to a second screen.

If it is decided in the electronic device that the screen is changed to the different screen, the electronic device may transmit an indication of a characteristic of the target area to a server Thereafter, the electronic device may receive a content 607 from the server, and may display the content in the selected target area.

For example, as shown in FIG. 6C, the target area may be situated in the left side of the display of the electronic device. Alternatively, as illustrated in FIG. 6D, the target area may be located in the middle of the bottom side of the electronic device's display.

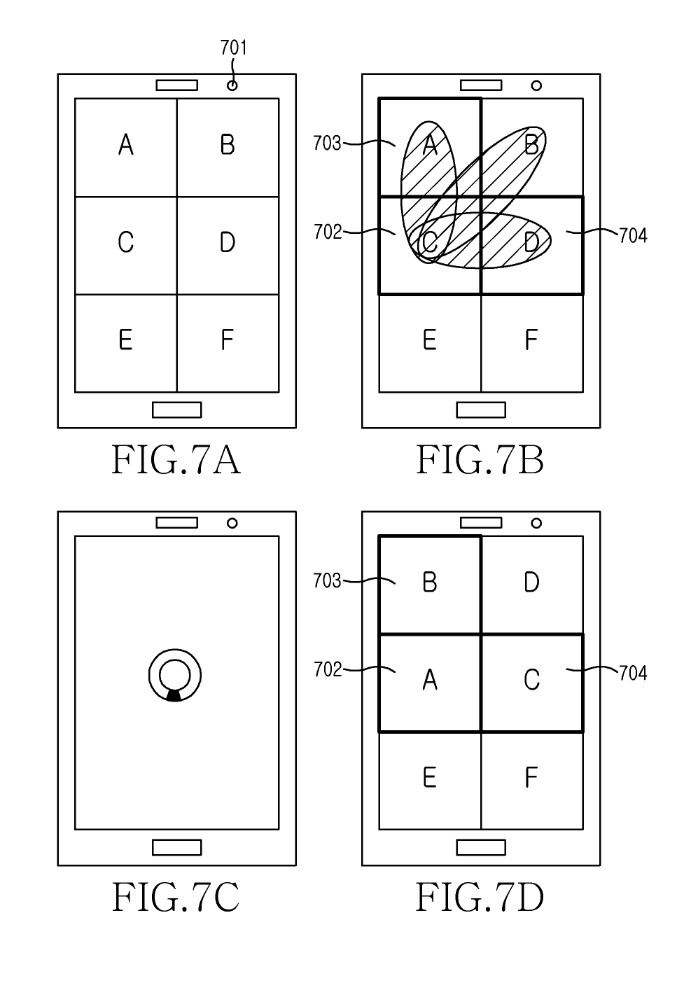

FIGS. 7A, 7B, 7C and 7D are diagrams illustrating an example of a process for displaying content, in accordance with aspects of the disclosure. First, an electronic device may display a specific application according to a priority of content. For example, an application executed in the electronic device is displayed in such a manner that six content items are displayed in respective 6 areas in a distinctive manner according respective priorities of the content items as shown in FIG. 7A.

In the aforementioned example, if a specific application is executed, the electronic device may display a screen of the application. Thereafter, the electronic device may accumulate eye-gaze data by using a camera module 701 included in the electronic device.

Thereafter, if it is decided in the electronic device that more than a threshold amount of eye-gaze data is accumulated, the electronic device may identify a concentration pattern of the eye-gaze data. Thereafter, the electronic device may re-arrange locations of contents displayed according to the identified pattern. In some aspects, identifying the concentration pattern may include identifying how often and/or for how long the user's gaze is directed at each of a plurality of predetermined screen sections.

For example, as shown in FIG. 7B, as a result of analyzing the concentration of the user's eye-gaze by the electronic device, it is detected an area (i.e., a target area 702) in which an eye-gaze concentration is the highest among 6 divided areas, an area (i.e., a second area 703) in which the eye-gaze concentration is the highest next to the target area, and an area (i.e., a 3rd area 704) in which the eye-gaze concentration is the lowest, and such a case will be described below. In some aspects, the concentration of the eye gaze with respect to an area may be measured by the frequency at which the eye gaze is directed in the area and/or an amount of time for which the eye gaze is rested on the area (e.g., a total amount of time during the period in which the eye-gaze data is collected).

In the aforementioned example, the electronic device may determine that a content A having a top priority, a content B having a second highest priority, and a content C having a 3^{rd} highest priority are re-arranged respectively in the target area 702, the second area 703, and the 3^{rd} area 704.

Thereafter, the electronic device may decide whether the initially displayed screen is changed to a different screen. More specifically, the electronic device may decide whether a first screen for a first application is changed to a second screen.

If it is decided that the electronic device is changed to the different screen after a loading operation of a screen change as shown in FIG. 7C, the electronic device may re-arrange locations of contents according to the eye-gaze concentration.

For example, as shown in FIG. 7D, the electronic device may re-arrange a content A having a first highest priority as a target area 702, a content B having a second highest priority as a second area 703, and a content C having a 3^{rd} highest priority as a 3^{rd} area 704. In other words, by way of example, the content having the highest priority may be displayed in an area of the screen associated with the highest gaze concentration (i.e., an area of the screen where the user's gaze is directed more often and/or for the longest period of time), while the content having the lowest priority may be displayed in another area of the screen that is associated with the lowest gaze detection (i.e., an area of the screen where the user's gaze is directed least often and/or for the shortest period of time).

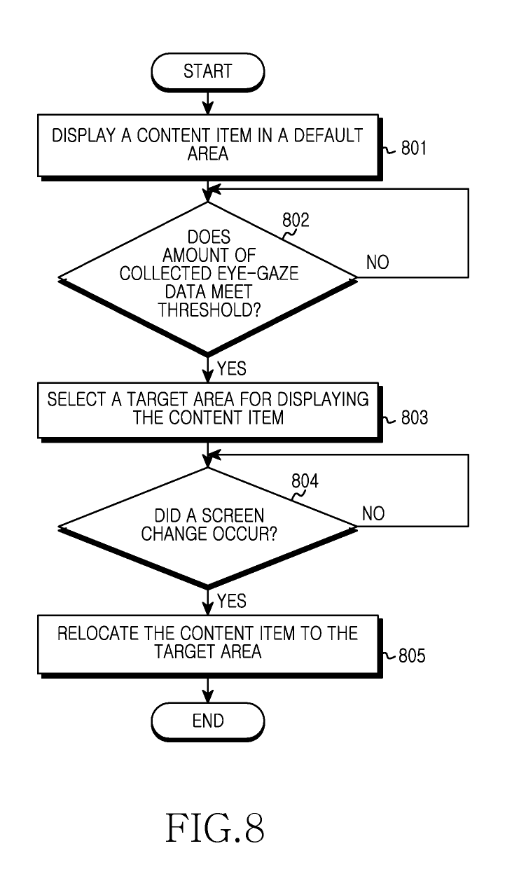

FIG. 8 is a flowchart of an example of a process for displaying content, according to aspects of the disclosure. First, as shown in FIG. 8, the electronic device may display a content in a default area in the display of the electronic device (step 801). According to aspects of the disclosure, the default area may be any area in the display of the electronic device.

Thereafter, the electronic device may detect whether eye-gaze data is accumulated in excess of a threshold amount (step 802).

Thereafter, if it is detected that the amount of eye-gaze data exceeds the threshold amount, the electronic device may select a target area for displaying the content based on the eye-gaze data (step 803). For example, the electronic device may analyze the eye-gaze data and may select any one of an area in which a user's eye-gaze is held more than a pre-set time and an area in which the user's eye-gaze is held less than the pre-set time as the target area.

Thereafter, the electronic device may detect whether a screen change takes place (step 804). More specifically, the electronic device may decide whether a first screen of a first application is replaced by a second screen. For example, both the first screen and the second screens may be screens of a chat application, wherein the first screen corresponds to a chat session with a “User A” and the second screen corresponds to a chat session with a “User B.”

If it is detected in the electronic device that the initially displayed screen is replaced with a second screen, the electronic device may display the content in the selected target area, thereby relocating the content from the default area to the target area (step 805).

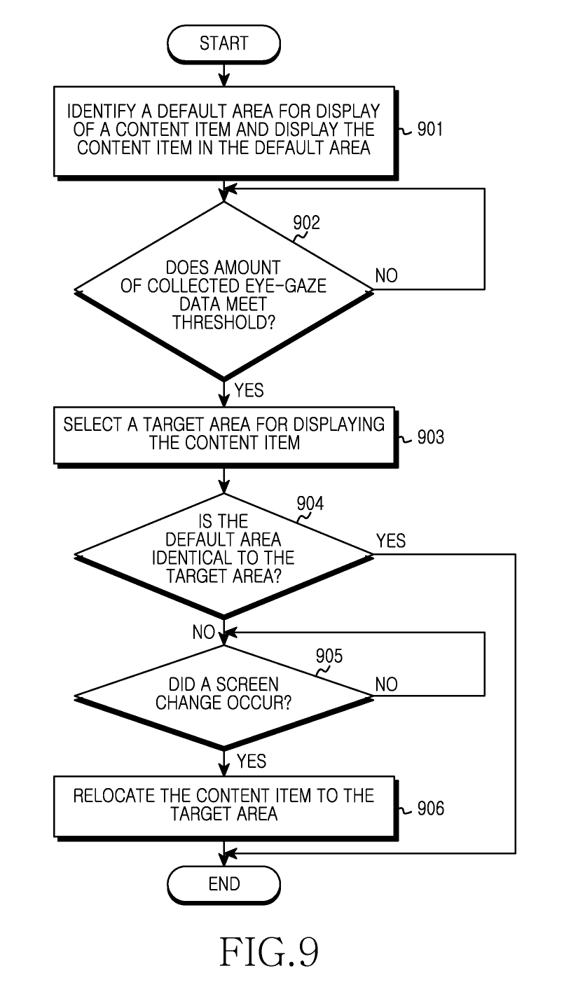

FIG. 9 is a flowchart of an example of a process for displaying content, according to aspects of the disclosure.

According to the process, an electronic device identifies a default area for display of a content item. In some aspects, the default area may be identified based on the identity of an application a screen of which is currently on display by the electronic device. After the default area is identified, the electronic device displays the content item in that area (step 901).

Thereafter, it may be decided whether eye-gaze data is accumulated in excess of a threshold amount (step 902).

If the amount of eye-gaze data exceeds the threshold amount, the electronic device may select a target area for displaying the content item based on the eye gaze data (step 903). The target area may be selected in accordance with any suitable technique, such as the techniques discussed with respect to FIGS. 4, 5A-D, 6A-D, and 7A-D.

Thereafter, the electronic device may detect whether the target area is identical to the default area (step 904).

If the electronic device detects that the target area is not identical to the default area, the electronic device may detect whether a screen displayed by the electronic device is changed (step 905).

If the screen is changed, the electronic device may display the content item in the target area (step 906).

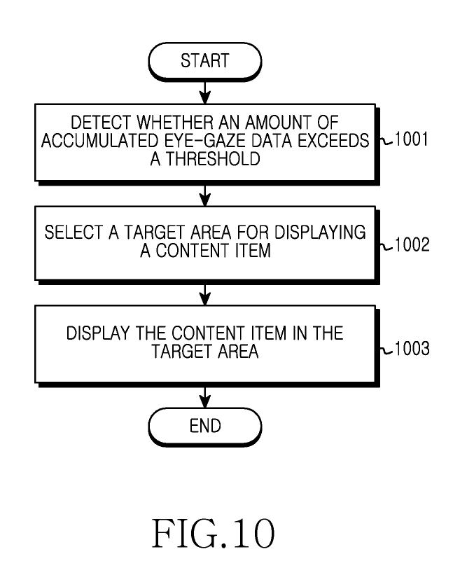

FIG. 10 is a flowchart of an example of a process for displaying content, according to aspects of the disclosure. First, as shown in FIG. 10, the electronic device may detect whether eye-gaze data is accumulated in excess of a threshold amount (step 1001). The eye gaze data may be accumulated via a camera module of the electronic device. Thereafter, if it is decided in the electronic device that the eye-gaze data is accumulated more than the pre-set data amount, the electronic device may select a target area for displaying a content item (step 1002). The target area may be selected in accordance with any suitable technique, such as the techniques discussed with respect to FIGS. 4, 5A-D, 6A-D, and 7A-D. Thereafter, the electronic device may display the content item in the target area (step 1003).

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

The figures provided throughout the disclosure and their accompanying discussions are provided as examples only. These examples, however, are not intended to be limiting in any way. Furthermore, these examples are not mutually exclusive and they can be used to supplement each other. At least some of the steps discussed with respect to FIGS. 1-10 can be performed concurrently, in a different order, or altogether omitted. It is to be understood that various changes in form and details may be made therein without departing from the spirit and scope of the present disclosure as defined by the appended claims.

What is claimed is:

1. A method comprising:
detecting, by an electronic device, whether at least a threshold amount of eye-gaze data is collected;
selecting a first area in a display of the electronic device based on the eye-gaze data when the threshold amount of eye-gaze data is collected; and
displaying a content item in the first area.

2. The method of claim 1, wherein the eye-gaze data indicates one or more locations on the display of the electronic device at which an eye-gaze is directed.

3. The method of claim 1, wherein the first area is selected based on at least one of a frequency at which an eye-gaze is directed at the first area and a duration for which the eye-gaze is directed at the first area.

4. The method of claim 1, further comprising:
displaying a first screen on the display of the electronic device;
transmitting an indication of a characteristic of the first area to a server in response to detecting that the first screen is replaced by a second screen; and
receiving the content item from the server.

5. The method of claim 1, wherein displaying the content item in the first area includes relocating the content item to the first area from a default area where the content item is initially displayed.

6. The method of claim 5, further comprising confirming that the default area is different from the first area.

7. The method of claim 1, wherein the first area is one at which an eye-gaze is directed most frequently from among a plurality of areas in the display of the electronic device.

8. The method of claim 1, wherein the first area is one at which an eye-gaze is directed least frequently from among a plurality of areas in the display of the electronic device.

9. The method of claim 5, wherein the content item is displayed in the first area in response to detecting that a first application screen is replaced by a second application screen on the display of the electronic device.

10. The method of claim 1, further comprising:
identifying an application whose screen is currently output on the display of the electronic device; and
displaying the content item in a default area of the display of the electronic device, the default area being an area that is associated with the application,
wherein displaying the content item in the first area includes relocating the content from the default area to the first area.

11. An electronic device comprising a display and a processor configured to:
detect whether at least a threshold amount of eye-gaze data is collected;
select a first area in the display based on the eye-gaze data when the threshold amount of eye-gaze data is collected; and
display a content item in the first area.

12. The electronic device of claim 11, wherein the eye-gaze data indicates one or more locations on the display of the electronic device at which an eye-gaze is directed.

13. The electronic device of claim 11, wherein the first area is selected based on at least one of a frequency at which an eye-gaze is directed at the first area and a duration for which the eye-gaze is directed at the first area.

14. The electronic device of claim 11, wherein the processor the processor is further configured to:
display a first screen on the display of the electronic device;
transmit an indication of a characteristic of the first area to a server in response to detecting that the first screen is replaced by a second screen; and
receive the content item from the server.

15. The electronic device of claim 11, wherein displaying the content item in the first area includes relocating the content item to the first area from a default area where the content item is initially displayed.

16. The electronic device of claim 15, wherein the processor is further configured to confirm that the default area is different from the first area.

17. The electronic device of claim 11, wherein the first area is one at which an eye-gaze is directed most frequently from among a plurality of areas in the display of the electronic device.

18. The electronic device of claim 11, wherein the first area is one at which an eye-gaze is directed least frequently from among a plurality of areas in the display of the electronic device.

19. The electronic device of claim 11, wherein the content item is displayed in the first area in response to detecting that a first application screen is replaced by a second application screen on the display of the electronic device.

20. The electronic device of claim 11, wherein the processor is further configured to:
identify an application whose screen is currently output on the display of the electronic device;
display the content item in a default area of the display of the electronic device, the default area being an area that is associated with the application,
wherein displaying the content item in the first area includes relocating the content from the default area to the first area.
